(19) United States
(12) Patent Application Publication
(10) Pub. No.: US 2013/0003870 A1
(43) Pub. Date: Jan. 3, 2013

(54) APPARATUS AND METHOD FOR VIDEO DATA PROCESSING

(75) Inventors: Philip L. Swan, Richmond Hill (CA); Christopher L. Spencer, Oviedo, FL (US)

(73) Assignees: ADVANCED MICRO DEVICES, INC., Sunnyvale, CA (US); ATI TECHNOLOGIES ULC, Markham (CA)

(21) Appl. No.: 13/174,873

(22) Filed: Jul. 1, 2011

(51) Int. Cl. H04N 7/26

(52) U.S. Cl. 375/240.26; 375/E07.026

(57) ABSTRACT

Methods and apparatus for accelerating the processing of image data are disclosed that are particularly useful in conducting graphical pattern searches. Embodiments of the invention conduct and implement comparative calculations of reference and search image pel data on a multi-pel comparative basis, particularly, sum of the absolute differences (SAD) based calculation comparisons.

### FIELD OF INVENTION

This application is related to processors and methods of video data processing acceleration.

### BACKGROUND

One widespread method of capturing and/or displaying images is through the use of pixel-based image capture and/or display. As electronic imaging resolution has increased along with the increased demand of “real time” video display, the demands for quick and efficient processing of video image data continues to increase.

For various types of video processing, such as video encoding, frame rate conversion, super-resolution, etc., it is desirable to perform motion estimation by finding where MBs of image data (or altered versions thereof) appear in a reference frame are located in a subsequent frame. Conventionally, the image data of a MB located a particular coordinate location in a reference frame is searched for in a subsequent frame within a search block that surrounds the MB reference block location.

In image processing, pixels are generally represented by pixel data elements, commonly referred to as pels, that are often byte sized. For example, a pel may be defined by eight bits of data that represents one byte of data in a particular image display application.

Performing a comparative calculation of differences between pels is used in a variety of video processing algorithms. Generally these operations are done to rapidly compare one set of pels to another. For example, such a comparison can form a base image correlation operation in many motion search algorithms.

In such correlations, it is desirable to obtain a calculation of the differences between pels of a reference image and pels of a search image. One comparative calculation technique is known as the sum of the absolute differences (SAD). Although a single-pel SAD comparison can be made, conducting multi-pel SAD comparison operations are preferred. In a conventional multi-pel SAD comparison operation, pel data of a predefined number of reference pels is compared with pel data of a predefined number of search image pels on an individual pel basis. In a conventional multi-pel SAD comparison operation, the absolute value of the differences of corresponding individual pels from each respective set are summed.

FIG. 1 illustrates an implementation of a conventional multi-pel SAD comparison calculation circuit 10. A first input 12 is configured to receive four bytes of pel data, each byte representing one of a set of four consecutive pels from a reference image. A second input 14 is configured to receive four bytes of pel data representing a set of four consecutive pels from a search image.

Four absolute value difference circuits 16a-d are provided, each configured to generate an absolute value of the difference in the values of pel data for a pel of the reference image received via the first input 12 with pel data of a corresponding pel of the search image received via the second input 14. For example, absolute value difference circuit 16a generates an absolute value of the difference in the value of pel data for the pel represented by Byte° of the reference image data and the value of pel data for the pel represented by Byte° of the search image data.

An adder 19 is provided that sums the results generated by the absolute value difference circuits 16a-d to provide a two byte output 20 representing a comparative value of the reference image set of four pels and the search image set of four pels.

Typically, a reference image will comprise many more pels then can be processed in one multi-pel SAD comparison calculation. For example a 4 pel by 16 pel reference image contains sixteen different 4 pel sets. In using a search algorithm to perform a comparison of such a 4 by 16 block of reference image pels with a 4 by 16 block of pels within a search image, the conventional multi-pel SAD comparison calculation may be conducted with respect to each of the sixteen different 4 pel sets of the reference area. Typically, these multi-pel SAD comparison calculations are done in series and the result of each prior calculation is accumulated into the next calculation.

To perform cumulative multi-pel, SAD comparison calculations, a merge value representing a comparison result (or an accumulated comparison result) with respect to one set of reference pels is accumulated with a subsequent SAD comparison calculation performed with respect to a “next” set of reference pels. Accordingly, the multi-pel, SAD comparison calculation circuit 10 includes a third input 22 configured to receive the merge value. The third input is coupled to the adder 19 or another type of merge device so that the previously produced comparative value generated by the previous multi-pel, SAD comparison operation and previously provided via output 20 is reflected in the comparative value for the multi-pel, SAD comparison calculation then being performed.

For accumulation, the merge value can be a comparative value previously produced by a preceding multi-pel SAD comparison calculation and output from output 20 or some variation thereof. For example the merge value could be determined by multiplying or dividing the result of a preceding multi-pel SAD comparison calculation by a constant and rounding prior. Generally, the merge value will be initiated to zero for a first multi-pel SAD comparison calculation and thereafter is some function of a prior multi-pel SAD comparison calculation within a given series of calculations to compare a block of reference pels and a corresponding block of search image pels.

For a motion-type search operation, generally the search image can be a selected larger display area encompassing a location where a smaller reference image had appeared. For example, the reference image may be a 4 by 16 pel block that had appeared in the center of a 12 by 24 pel search image. The reference image may have moved from the original center location to another location within the 12 by 24 pel search image. Accordingly, it may be required to make a comparison of the reference image with each different 4 by 16 pel block within the 12 by 24 pel search image. Accordingly, many, many multi-pel SAD comparison calculations are required. In this case, a series of 16 cumulative multi-pel SAD comparison calculations may be required for each of 64 different searches that compare the reference image to each of 64 different 4 by 16 pel block within the 12 by 24 pel search image.

For example, for a first comparison search, a first multi-pel SAD comparison calculation may be commence with a first set of four pels of a reference image, [r0, r1, r2, r3] with respect to a first set of four pels of a search image, [s0, s1, s2, s3]. A second SAD operation of the first search would be conducted with a second set of four pels of the reference image, [r4, r5, r6, r7] with respect to a second set of four pels of the search image, [s4, s5, s6, s7] with the result of the first SAD operation being accumulated (added) into the result being generated for the second SAD operation of the first search. The first comparison search then continues based on four pel increments until a complete comparison with the 4 by 16 block of reference pels is made.

A second comparison search may then be conducted starting with a first multi-pel SAD comparison operation of the reference image pels with respect to respective incremental sets of search image pels such as [s1, s2, s3, 4], [s2, s3, s4, s5], [s3, s4, s5, s6], [s4, s5, s6, s7] etc. As noted above, for a 4 by 16 pel reference image, sixteen multi-pel SAD comparison calculations are performed for each search. In addition, within each series of multi-pel SAD comparison operations, a shift type operation is required to be performed with respect to address of the pel values input to the multi-pel SAD comparison calculation circuit 10 for the next multi-pel SAD comparison operation to compare a next pair of reference and search image sets of pels.

In some instances, it is desirable to search for an irregularly shaped object contained in a reference image so that the reference image is comprised of pels defining the object (“object pels”) and pels that are not part of the object, such as pels displaying background behind the object (“background pels”). In searching for such an object, it is immaterial whether or not a match is found with respect to the background pels, since they are not part of the object being searched for.

The conventional multi-pel SAD comparison operation, however, is based upon the premise that all of the pels of the reference image are pertinent to the search. This is problematic where an object within the reference image is the subject of the search and the reference image is comprised of object pels and background pels. The conventional multi-pel SAD comparison calculation can produce erroneous results attributable to any background pels within a set of pels being compared in searching the search image for a specific object contained in the reference image. This can give rise to a need to perform individual pel SAD comparison calculations instead of utilizing the multi-pel SAD comparison calculation of FIG. 1. Where such an object search is to be conducted, the number of processing operations involved in comparing the reference image to the search image as in connection with performing a search algorithm is further increased, since the conventional multi-pel SAD comparison operation cannot be uniformly used without the risk of erroneous results.

In the context of computer execution of image search algorithms, the number of times various operation need to be performed can be a significant factor in the overall processing speed that can be achieved. A SAD OpCode (operation code) is known with respect to instructing an arithmetic logic unit (ALU) of a processor to conduct the conventional multi-pel SAD comparison operation represented in the FIG. 1 diagram. Typically, each multi-pel SAD comparison operation is performed by the ALU of a processor execution unit in response to the execution unit processing a microinstruction that identifies the SAD OpCode. Typically, after a SAD microinstruction is received, the execution unit will receive a microinstruction for at least one data shifting operation. Such a data shifting operation is generally required to provide a different input set of data for at least one of the multi-pel SAD comparison operation inputs for a next SAD microinstruction that is to be performed in the performance of a video search algorithm.

### SUMMARY OF THE EMBODIMENTS

Methods and apparatus for accelerating the processing of image data are disclosed that are particularly useful in conducting graphical pattern searches. Embodiments of the invention conduct and implement comparative calculations of reference and image pel data on a multi-pel comparison basis, particularly, sum of the absolute differences (SAD) based calculation comparisons.

### BRIEF DESCRIPTION OF THE DRAWINGS

FIG. 1 is a circuit diagram of an implementation of a conventional SAD pel set comparison calculation circuit.

FIG. 2 is a circuit diagram of an implementation of a Masked SAD pel set comparison calculation circuit within an apparatus according to the teachings of the present invention.

FIG. 3 is a circuit diagram of an implementation of a multi-operation pel set comparison calculation circuit within an apparatus according to the teachings of the present invention.

FIG. 4 is a graphic illustration of an initial Masked Quad SAD operation for a search for a reference image within a search area according to the teachings of the present invention.

FIG. 5 is a graphic illustration of a second Masked Quad SAD operation for the search for the reference image of FIG. 4.

### DETAILED DESCRIPTION OF THE PREFERRED EMBODIMENTS

The following description of specific examples of the present invention is non-limiting. The examples are not intended to limit the scope and content of this disclosure.

For various types of video processing, such as video encoding, frame rate conversion, super-resolution, etc., it is desirable to perform motion estimation by finding where blocks of image data (or altered versions thereof) appear in a reference frame are located in a subsequent frame. In order to support real time or fast than real time capture and/or display of video where motion estimation is used, all of the searches for image blocks of a reference frame must be fast enough so that video processing can be timely completed. The amount of processing required is generally related to the resolution of the video frames that are being processed.

Although a specific type of pel data comparison disclosed in the following examples is based on a sum of the absolute differences (SAD) calculation, the invention is not limited to such a specific arithmetic comparative operation between reference pel data and search image pel data. Other types of comparisons may be used in place of the SAD calculation.

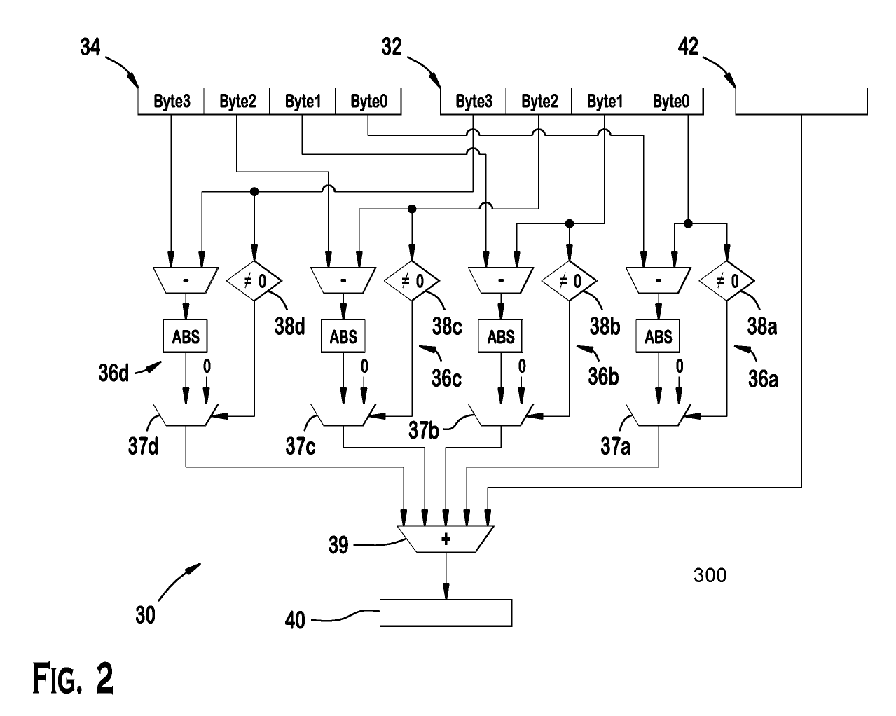

Referring to FIG. 2, an implementation of a multi-pel Masked SAD comparison calculation circuit 30 is illustrated. The multi-pel Masked SAD comparison circuit/calculation/operation is referred to below simply as the “Masked SAD” circuit/calculation/operation.

Preferably the multi-pel Masked SAD comparison calculation circuit 30 is an integral part of a system 300 that captures and/or displays video in connection with video motion estimation processing associated with video processing such as video encoding, frame rate conversion, super-resolution, etc. Such systems 300 include, but are not limited to, video recorders, camcorders, video cameras and other type of video capture devices, personal computers and other types of devices that display video, computer displays, televisions and other types of display devices. In particular, the multi-pel Masked SAD comparison calculation circuit 30 and associated methods described below apparatus can be advantageously incorporated and/or employed where such devices use high speed capture and/or high speed display of high resolution video.

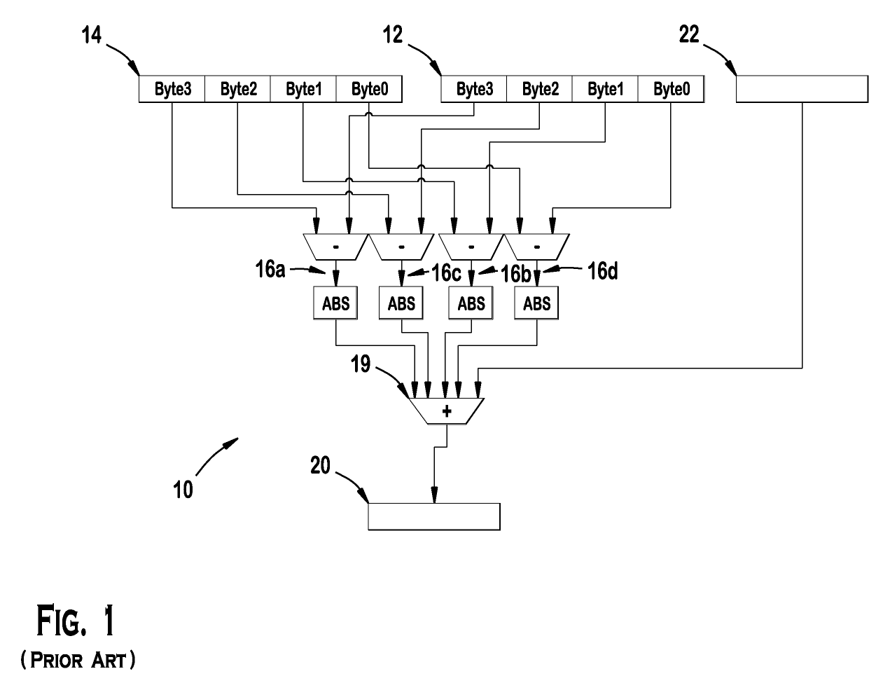

Similar to the conventional multi-pel SAD comparison circuit of FIG. 1, the Masked SAD circuit 30 has a first input 32 and a second input 34 configured to receive pel data representing equal sized sets of pels of respective reference and search images. Generally, the first input 32 and second input 34 are configured to receive a data vector of a plurality of words that may be defined as having a predetermined byte or bit size. Preferably, the data vector word size is a power of two, such as 8-bit, 16-bit or 32-bit words. In the example shown in FIG. 2, the first input 32 is preferably configured to receive four single-byte words of pel data, each byte representing one of a set of four consecutive pels of the reference image and the second input 34 is configured to receive four bytes of pel data representing a set of four consecutive pels of the search image. However, other pel and data set sizes can be used for example a pel could be represented by 4, 10 or 16 bits of data. If the number of bits in a pel is not a power of two then some padding may optionally added to still allow the total size of a data set to be a convenient power of two.

Unlike the conventional multi-pel SAD comparison circuit of FIG. 1, the Masked SAD circuit 30 is configured to perform pel set comparison calculations even where an object within the reference image is the subject of the search such that the set of reference pels contains both object pels for which a valid comparison is needed and background pels for which it is immaterial whether there is a valid comparison. For example, a reference image may be defined with respect to a rectangular collection of x rows of pels in y columns, i.e. pels r1, r12 . . . r1y, r21 . . . r2y . . . rx1 . . . rxy where each pel is either part of an object of interest (an “object pel”) or purely a background pel.

Both object pels and background pels in the reference image can typically be within a predetermined range of values in a source image from which the reference image is taken. In YUV video, for example, pels have a nominal value range of 16-235. YUV video is a type of video signal that consists of three separate signals: 1 for luminance (brightness) and two for chrominance (colors).

Various manners of identifying object and background pels in a reference image are well known in the art. Conventionally, pixels are identified by an object segmentation algorithm as being part of the object or not being part of the object. Typically adapting the SAD calculations to only sum object pels prevents full time use of the more efficient multi-pel SAD comparison operation depicted in FIG. 1, and requires additional costly operations to locate consecutive groups of pixels where the more efficient multi-pel SAD comparison operation can be used. Failing to exclude the background pels leads to generation of SAD results that are false negatives—indicating that no good match was found even along a correct motion trajectory for the object where the background's motion was not on the object's motion trajectory. Thus, the search image can contained different background pels that provide an erroneous result when using the conventional multi-pel SAD comparison calculation. Accordingly, background pels, if not excluded, can distort the results of a motion search for an object contained in a reference image using the conventional multi-pel SAD comparison operation.

Where a search image is to be searched to find a specific object contained in a reference image, the pel data for the reference image is preprocessed to set pel data for any background pels within the reference image to a fixed value outside the typical pel value range. The example Masked SAD circuit 30 is configured to make pel set comparison calculations where the typical pel value range of pels in the reference image excludes zero and the value of any background pels is set to zero in defining the reference pel set data to be received by input 32 of Masked SAD circuit 30. The Masked SAD operation facilitates searching for objects of higher resolution and in a more uniform manner through which accelerated processing speed and searching accuracy may be achieved, since the Masked SAD operation can be utilized with respect to reference images comprised of both object and background pels.

The Masked SAD circuit 30 has a plurality of processing circuits 36a-d, preferably corresponding in number to the number of pels in the reference and search image pel sets for which the first and second inputs 32, 34 are respectively configured to receive pel data. In the example shown in FIG. 2, the Masked SAD circuit 30 is configured to conduct a comparison of reference and search image pel sets having four pels, so there are four processing circuits 36a-d.

Each processing circuit 36a-d is preferably configured to generate an absolute value of the difference in the values of pel data for a pel of the reference image received via the first input 32 with pel data of a corresponding pel of the search image received via the second input 34 and to direct that generated value to a respective multiplex component 37a-d of the processing circuit. For example, processing circuit 36a generates an absolute value of the difference in the value of pel data for the pel represented by Byte° of the reference image data and the value of pel data for the pel represented by Byte0 of the search image data. The result of the calculation made by processing circuit 36a is passed to multiplex component 37a.

Each processing circuit 36a-d also includes a respective comparator component 38a-d coupled with the reference image data input 34 that is configured to direct a control signal to the respective multiplex component 37a-d. Each comparator component 38a-d is configured to control the respective multiplex component 37a-d to output a predetermined value if the reference pel data value being processed by the respective processing circuit is a value that identifies that reference set pel as a background pel. If the reference pel data value being processed by the respective processing circuit 36a-d is a value that does not identify that reference set pel as a background pel, the respective multiplex component 37a-d is configured to output the generated absolute value of the difference pel values being processed by the respective processing circuit 36a-d. The predetermined value output when a background pel is being processed is preferably selected to be the same or very close to the value generated by a comparison of matching reference and search image pels.

In the illustrated example of FIG. 2, a zero value is the value that is used to identify a reference set pel as a background pel and values of reference set object pels are non-zero, so that the comparator components 38a-d can determine whether the respective reference pel values being processed by their respective processing circuits 36a-d are non-zero to determine how to control the respective multiplex components 37a-d. Also a zero value is selected as the predetermined value output by the respective multiplex component 37a-d when a background pel is being processed, since a value that is 0 or very close to 0 is the value generated by a SAD comparison of matching reference and search image pels.

In an example Masked SAD operation, processing circuit 36a generates an absolute value of the difference in the value of pel data for the pel represented by Byte° of the reference image data and the value of pel data for the pel represented by Byte° of the search image data, which value is then passed to multiplex component 37a. However, the comparator components 38a will control the value output by multiplex component 37a to be the predetermined zero value if the value of pel data for the pel represented by Byte° of the reference image data is zero.

A merge component, such as an adder, 39 is provided that merges, preferably sums, the results output from the multiplex components 37a-d of the processing circuits 36a-d to provide an output 40. In lieu of simple addition, the merge component can be configured to use any suitable merge function. For example, the merge component can be configured to multiply or divide the results output from the multiplex components 37a-d by a constant and/or to perform rounding in performing the merge function in order to provide a result reflective of the multi-pel comparison being performed.

Generally, the output 40 is configured to output a data vector of one or more words that may be defined as having a predetermined byte or bit size and that may represent either fixed or floating point values. In the illustrated example, preferably, the output data vector from output 40 is a sixteen-bit word representing a comparative value of a comparison of four pels of the reference image and four pels of the search image. This value is not distorted even if the set of four pels of the reference image contains background pels since the contribution to the comparative value attributable to any such background pels is 0.

Preferably support for cumulative Masked SAD calculations is provided where a merge value is merged into the result of the Masked SAD calculation. To perform cumulative Masked SAD calculations, a merge value, preferably representing a comparison result (or an accumulated comparison result) with respect to one set of reference pels, is accumulated with a subsequent Masked SAD calculation performed with respect to a “next” set of reference pels.

For accumulation, the merge value is preferably a comparative value previously produced by a preceding Masked SAD calculation and output from output 40 or some variation thereof. For example the merge value could be determined by multiplying or dividing the result of a preceding Masked SAD calculation by a constant and rounding prior. Generally, the merge value will be initiated to zero for a first of a series of Masked SAD calculations and thereafter the merge value will be some function of a prior Masked SAD calculation within a given series of calculations to compare a block of reference pels and a corresponding block of search image pels.

For example, for a given comparison search, a first cumulative Masked SAD operation may commence with respect to a first set of four pels of a reference image, [r0, r1, r2, r3] and a first set of four pels of a search image, [s0, s1, s2, s3]. A “next” Masked SAD operation of the given search could then be conducted with respect to a “next” set of four pels of the reference image, [r4, r5, r6, r7] and a next set of four pels of the search image, [s4, s5, s6, s7]. The series of cumulative Masked SAD operations would typically continue for the given search, until all of the pels of the reference image have been compared with corresponding pels of the search image.

As illustrated, the example Masked SAD circuit 30 includes a third input 42 configured to receive the merge value. The third input is coupled to the adder or another type of merge device 39 so that the previously produced comparative value generated by the previous Masked SAD operation and previously provided via output 40 is reflected in the comparative value for the Masked SAD calculation then being performed.

Generally, the third input 42 is configured to receive a data vector of one or more words that may be defined as having a predetermined byte or bit size and that may represent either fixed or floating point values. Preferably, the third input 42 receives as its input a comparative value previously produced with respect to a pair of sets of reference and search image pels within a given cumulative search. In the Example of FIG. 2, such input is preferably a sixteen-bit word previously output from output 40. In such case, the third input is coupled to the merge component configured as an adder 39 so that the previously produced comparative value is added into the comparative value for a next Masked SAD calculation within a series of Masked SAD operation being performed for a cumulative search.

In lieu of simply adding a prior comparative value to the Masked SAD calculation, the merge component 39 may be configured to otherwise combine the merge value with the results output from the multiplex components 37a-d of the processing circuits 36a-d. Examples for the configuration of the merge component 39 include but are not limited to being configured to perform an Add that saturates at a maximum value, to perform an Add that wraps, to perform an Add that generates a carry or to perform an Add that wraps and generates a carry.

Preferably, a Masked SAD OpCode (operation code) is defined that is used to instruct an arithmetic logic unit of an execution unit of a processor to conduct the Masked SAD calculations described above in connection with FIG. 2. As with the conventional SAD operation, the Masked SAD operation described above will typically alternate with at least one data shifting operation to provide a different input set pair of pel data for a next Masked SAD operation within a series of Masked SAD operations to be performed for a given cumulative search.

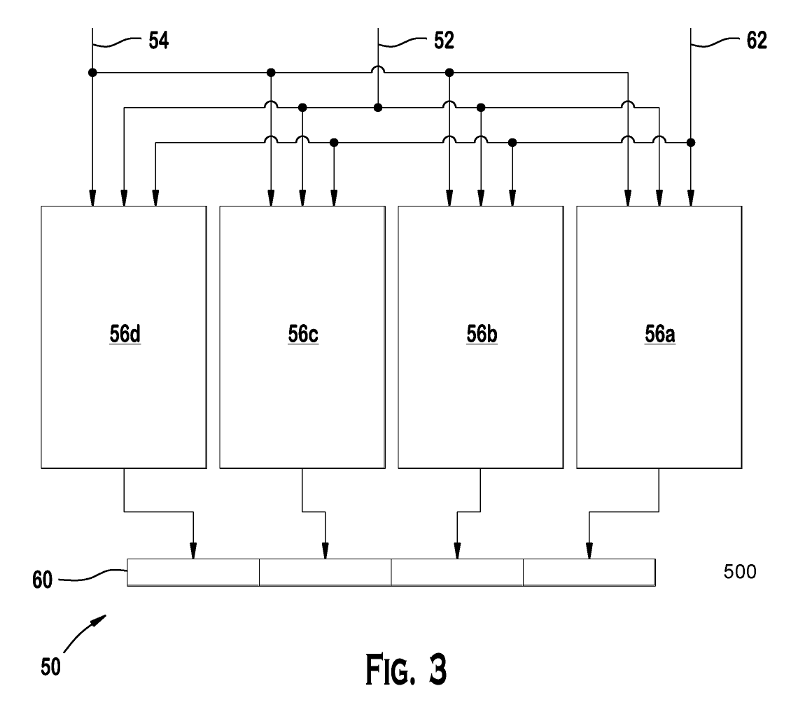

FIG. 3 illustrates an example of a further embodiment of a video image data processing circuit made in accordance with the teachings of the present invention where there is a consolidation of pel set comparison calculations. Referring to FIG. 3, a multi-operation pel set comparison calculation circuit 50 is illustrated.

Preferably the multi-operation pel set comparison calculation circuit 50 is an integral part of a system 500 that captures and/or displays video in connection with video motion estimation processing associated with video processing such as video encoding, frame rate conversion, super-resolution, etc. Such systems 500 include, but are not limited to, video recorders, camcorders, video cameras and other type of video capture devices, personal computers and other types of devices that display video, computer displays, televisions and other types of display devices. In particular, the multi-operation pel set comparison calculation circuit 50 and associated methods described below apparatus can be advantageously incorporated and/or employed where such devices use high speed capture and/or high speed display of high resolution video.

The circuit 50 includes a first input 52 configured to receive pel data for a set of a predetermined number N of pels of a reference image, where N is at least 2. Generally, the first input 52 is configured to receive a data vector of a plurality of N words that may be defined as having a predetermined byte or bit size. Preferably, the data vector word size is a power of two, such as 8-bit, 16-bit or 32-bit words. In the illustrated example, the first input 52 is configured to receive pel data with respect to a set of four pels of the reference image. Preferably, the pel data represents four consecutive eight-bit bytes and the input 52 is a 32-bit input.

A second input 54 is configured to receive pel data for a set of a predetermined number M of pels of a search image where M is greater than N. Generally, the second input 54 is configured to receive a data vector of a plurality of M words that may be defined as having a predetermined byte or bit size. Preferably, the data vector word size is a power of two, such as 8-bit, 16-bit or 32-bit words. In the illustrated example, the second input 54 is configured to receive pel data with respect to a set of at least seven pels of the search image. The second input 54 is preferably configured to receive pel data with respect to a set of eight consecutive pels of the search image that are represented in eight eight-bit bytes and the input 54 is a 64-bit input.

The first and second inputs 52, 54 are selectively coupled to a plurality of K arithmetic circuits 56a-d. Each K arithmetic circuit 56a-d is configured to process the pel data for the set of N pels received via the first input 52 with pel data for a search image pel subset of N pels of the set of M pels received via the second input 54 such that the search image pel subset used by each arithmetic circuit 56a-d contains pel data with respect to different subsets of the set of M pels. In the illustrated example, there are four arithmetic circuits 56a-d.

Arithmetic circuit 56a is configured to process the pel data for the set of four pels of the reference image received via the first input 52 with the pel data for a search image pel subset of made up of the first, second, third and fourth pels of the set of eight pels of the search image received via the second input 54. Arithmetic circuit 56b is configured to process the pel data for the set of four pels of the reference image received via the first input 52 with the pel data for a search image pel subset of made up of the second, third, fourth and fifth pels of the set of eight pels of the search image received via the second input 54. Arithmetic circuit 56c is configured to process the pel data for the set of four pels of the reference image received via the first input 52 with the pel data for a search image pel subset of made up of the third, fourth, fifth and sixth pels of the set of eight pels of the search image received via the second input 54. Arithmetic circuit 56d is configured to process the pel data for the set of four pels of the reference image received via the first input 52 with the pel data for a search image pel subset of made up of the fourth, fifth, sixth and seventh pels of the set of eight pels of the search image received via the second input 54.

Optionally, a fifth arithmetic circuit can be provided to process the pel data for the set of four pels or the reference image received via the first input 52 with the pel data for a search image pel subset of last four pels of the set of eight pels of the search image received via the second input 54. However, a configuration containing four arithmetic circuits is preferred for preserving computational efficiency and resources in the normal binary-based processing of video data. For similar reasons the second input is configured as a 64-bit input even though only first 56 bits of the inputted data are processed, since the data representing the eighth pel of the search image pel set is not processed by any of the illustrated arithmetic circuits 56a-d.

Each arithmetic circuit 56a-d is configured to provide an output. Generally, each arithmetic circuit 56a-d 40 is configured to output a data vector of one or more words that may be defined as having a predetermined byte or bit size and that may represent either fixed or floating point values. Preferably, each output data vector is a sixteen-bit word. Preferably, the output vectors from all of the arithmetic circuits 56a-d are collectively output as a single vector from an output 60 of the multi-operation pel set comparison calculation circuit 50.

In the example illustrated in FIG. 3, the output vector from each arithmetic circuit 56a-d is preferably a sixteen-bit word. The outputs from all of the arithmetic circuits 56a-d are collectively output as four sixteen-bit words from output 60 of the example multi-operation pel set comparison calculation circuit 50 of FIG. 3. Each sixteen-bit word output from the arithmetic circuits 56a-d represents a comparison result generated with respect to one of the search image pel subsets and the set of pels of the reference image.

For example, arithmetic circuit 56a provides a first sixteen-bit word of the four sixteen-bit word output of output 60 that represents a comparison result generated with respect to the search image pel subset made up of the first, second, third and fourth pels of the set of eight pels of the search image and the set of pels of the reference image. Arithmetic circuit 56d provides a fourth sixteen-bit word of the four sixteen-bit word output of output 60 that represents a comparison result generated with respect to the search image pel subset made up of the fourth, fifth, sixth and seventh pels of the set of eight pels of the search image and the set of pels of the reference image.

Each arithmetic circuit 56a-d is preferably configured to perform a multi-pel SAD or other multi-pel comparison type operation. For example, each arithmetic circuit 56a-d may be configured in accordance to FIG. 1 to perform the conventional multi-pel SAD operation discussed above. With such a configuration, the example multi-operation pel set comparison calculation circuit 50 performs four multi-pel SAD operations in parallel, i.e. a Quad-SAD operation.

Each arithmetic circuit 56a-d is preferably configured to perform the Masked SAD operation as illustrated and described in accordance with FIG. 2. Thus making multi-operation pel set comparison calculation circuit 50 suitable for use in producing comparative calculations results with respect to searching for an object contained in reference image comprised of object pels and background pels. In such instance the first input 52 is preferably configured to receive preprocessed pel data as discussed above with respect to first input 32 of the Masked SAD circuit 30. With such a configuration, the example multi-operation pel set comparison calculation circuit 50 performs four Masked SAD operations in parallel, i.e. a Masked Quad-SAD operation.

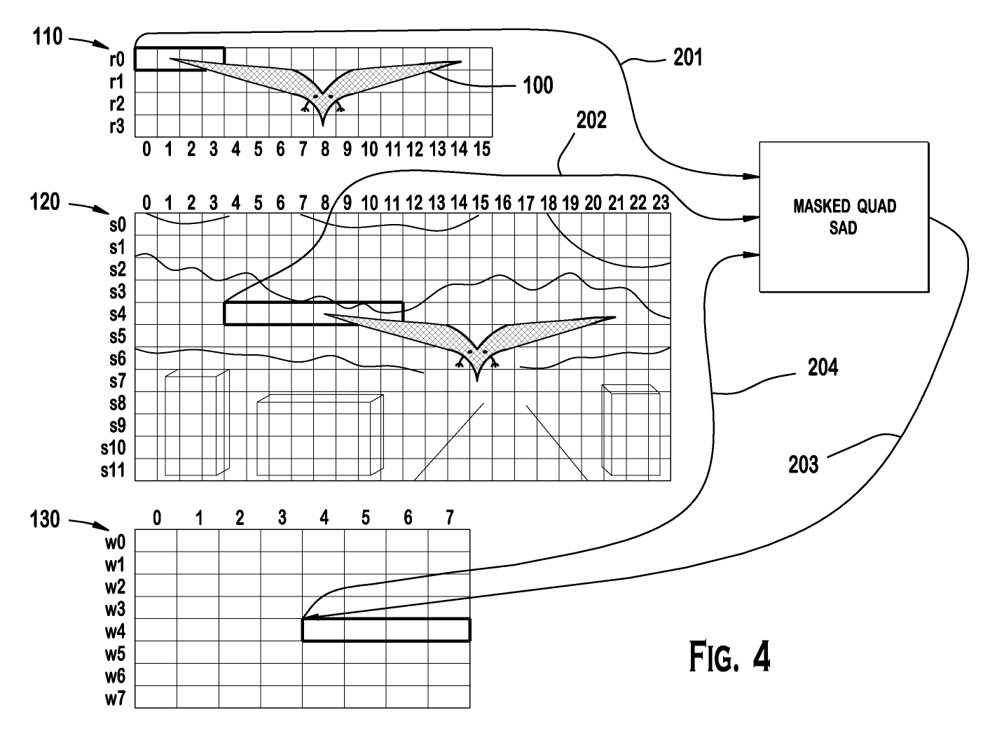

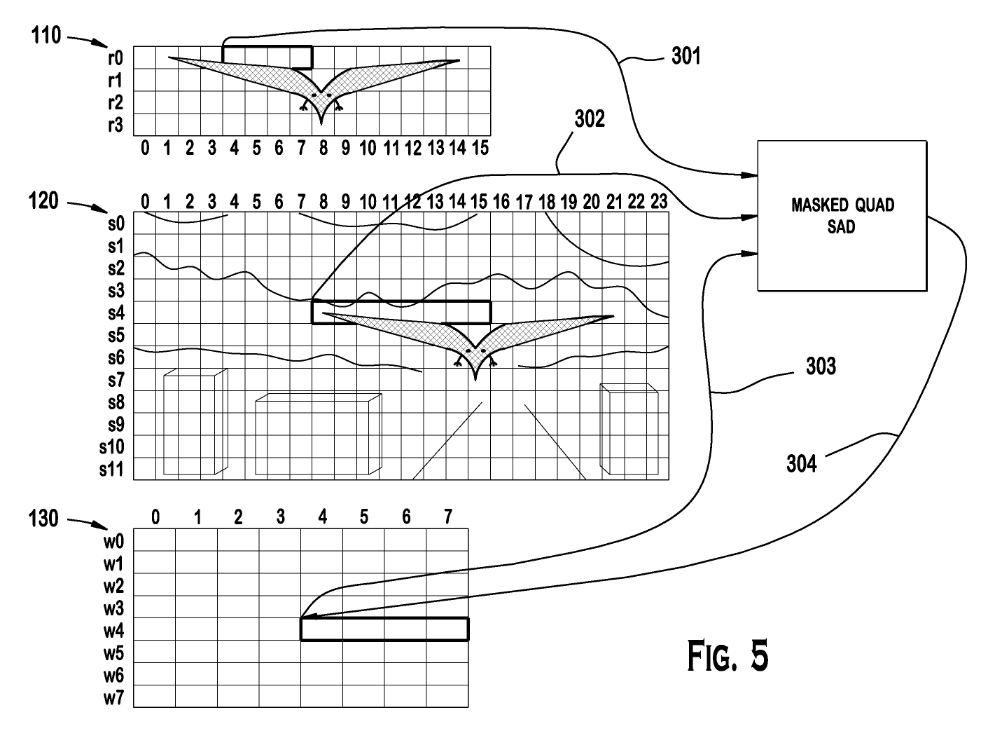

Preferably support for cumulative Quad SAD calculations is provided where a merge value is merged into the result of each SAD calculation. For example, a prior result produced from the output 60 can represent four comparison results with respect to a reference image set of pels and four different subsets of a search image set of pels. Such a prior result can be accumulated with a subsequent Quad-SAD calculation performed with respect to a “next” set of reference image pels and four similar subsets of a next set of search image pels. Such a cumulative Quad-SAD calculation will typically be performed in connection with concurrently conducting multiple searches of the reference image within corresponding blocks of the search image as explained in more detail below with respect to FIGS. 4 and 5. However, in lieu of simply accumulating a prior comparative value to a SAD calculation, each arithmetic circuit 56a-d may be configured to otherwise merge a merge value with the result it outputs, for example, as discussed with respect to the Masked SAD circuit 30 above.

For cumulative calculation support, the multi operation pel set comparison calculation circuit, such as example circuit 50, preferably includes a third input 62 configured to receive a set of merge values. The third input is preferably selectively coupled to each arithmetic circuit 56a-d so that a respective merge value from the inputted set of merge values is merged with that arithmetic circuit's output. Generally, the third input 62 is configured to receive a data vector of words that may be defined as having a predetermined byte or bit size and that may represent either fixed or floating point values. Preferably, this input data vector size is the same size as the collective output data vector output from output 60. For example, the set of merge values received via the third input 62 may be a prior result (or derivative thereof) produced from the output 60 that represents four comparison results (or cumulative comparison results) with respect to a reference image set of pels and four subsets of a search image set of pels. The third input 62 is selectively coupled to the arithmetic circuits 56a-d to provide each with a third input such that a respective portion of the prior result is added or otherwise merged into the comparison result being generated by the respective arithmetic circuits 56a-d.

In the example multi-operation pel set comparison calculation circuit 50 of FIG. 3, the third input 62 is configured to selectively receive four sixteen-bit words. The third input 62 is coupled the arithmetic circuits 56a-d to provide a respective sixteen-bit word representing a prior Quad SAD result (or prior cumulative result) to each of the arithmetic circuits 56a-d. For example, for a cumulative operation, where a prior result from output 60 is input to the third input 62 in the form of data made of four sixteen-bit words, the first sixteen-bit word is directed to the arithmetic circuit 56a and the fourth sixteen-bit word is directed to the arithmetic circuit 56d. Where a Quad SAD calculation is being made for the same sets of reference and search image pels for which the prior result was produced, each respective reference set/search image pel subset comparison calculation will be accumulated with a respective portion of the prior result.

Preferably, a Quad SAD OpCode is defined that is used to instruct an arithmetic logic unit of an execution unit of a processor to conduct the Quad SAD calculations described above in connection with FIG. 3 having each of its arithmetic circuits 56a-d configured to perform the SAD operation discussed with respect to FIG. 1. More preferably, a Masked Quad SAD OpCode is defined that is used to instruct an arithmetic logic unit of an execution unit of a processor to conduct the Masked Quad SAD calculations described above in connection with FIG. 3 having each of its arithmetic circuits 56a-d configured to perform the Masked SAD operation discussed with respect to FIG. 2. The use of such Quad SAD and/or Masked SAD operations can greatly reduce the number of shifting operations required to perform a video image search.

FIG. 4 is a graphic depiction of a Masked Quad SAD operation being performed with the multi-operation pel set comparison calculation circuit 50 that has each of its arithmetic circuits 56a-d configured to perform the Masked SAD operation discussed with respect to FIG. 2.

In this context, a search algorithm requiring multiple cumulative searches is being performed to locate a bird object contained in a reference image 110 within a search image 120. The reference image 110 includes object pels that contain at least a portion of the bird object and background pels that do not contain any portion of the bird object so that a uniform rectangular reference image is defined for which to conduct the search algorithm. The background of the reference image is blank in the example for clarity and to also reflect the preprocessing of the reference image to set the background pels to a 0 value.

In this example, the reference image 110 is defined by a 4 by 16 block of pels, (r0,0) . . . (r3,15), and the search image 120 is defined by a larger 12 by 24 block of pels, (s0,0) . . . (s11,23). The search algorithm proceeds by comparing the reference image pels to different 4 by 16 blocks of pels within the search image. A first cumulative comparative search of pels having been conducted with respect to a 4 by 16 block of pels that has pel (s0,0) of the search image as its upper left most pel.

With respect to FIG. 4, the search algorithm has reach a point where it is desirable to perform cumulative searches using multi-pel SAD comparative calculations with 4 by 16 blocks of pels spanning the fifth-eighth rows pels of the search image 120. Four searches are being commenced, namely searches of 4 by 16 blocks of pels that respectively have pel (s4,4), pel (s4,5), pel (s4,6) and pel (s4,7) of the search image as their upper left most pel, hereinafter referred to as Block 4,4, Block 4,5, Block 4,6 and Block 4,7, respectively. Each search commencing with a comparison with respect to a first set of reference pels, [(r0,0), (r0,1), (r0,2), (r0,3)].

The first set of reference pels includes a background pel, namely pel (r0,0), that forms no part of the bird object 100. This would normally disqualify the reference pel set as a candidate for the conventional multi-pel SAD comparison operation. However, in this case the Masked SAD operation is available so that the reference pels, such as pel (r0,0), will not distort the SAD calculation made with respect to the object pels that make up the bird object in conducting the cumulative multi-pel SAD comparative calculations.

Preferably, these four searches using the Masked Quad SAD operation are commenced through providing a microinstruction to the execution unit of a processor that identifies the Masked Quad SAD operation as the operation to be performed using specified data for first and second operation inputs. The pel values of the set of reference pels, [(r0,0), (r0,1), (r0,2), (r0,3)] is specified as a first input as represented by 201; the pel values of a set of search image pels, [(s4,4), (s4,5), (s4,6), (s4,7), (s4,8), (s4,9), (s4,10), (s4,11)] is specified as the second input as represented by 202.

The Masked Quad SAD operation is preferably performed by the execution unit of the processor as described above to produce an output 203 of four sixteen-bit words that represent four comparison results with respect to the reference set of pels and four subsets of a search image set of pels. In the example illustrated in FIG. 4, a SAD value memory array 130 is preferably provided for storing words, (W0,0) . . . (W7,7). The output 203 is directed to the SAD value memory array 130 and is stored in four words, (W4,4), (W4,5), (W4,6) and (W4,7).

The word stored at word (W4,4) resulting from the Masked Quad SAD operation illustrated in FIG. 4 represents the comparison result of the reference pel set [(r0,0), (r0,1), (r0,2), (r0,3)] with a pel subset [(s4,4), (s4,5), (s4,6), (s4,7)] of the search image set of pels. This represents the comparison of the initial four pels of the reference image with the initial four pels the Block 4,4 of the search image.

Similarly, the word stored at word W4,5 represent the comparison result of the reference pel set [(r0,0), (r0,1), (r0,2), (r0,3)] with a pel subset [(s4,5), (s4,6), (s4,7), (s4,8)] of the search image set of pels. The two bytes stored at word W4,6 represent the comparison result of the reference pel set [(r0,0), (r0,1), (r0,2), (r0,3)] with a pel subset [(s4,6), (s4,7), (s4,8), (s4,9)] of the search image set of pels. The two bytes stored in the SAD value memory array 130 at word W4,7 represent the comparison result of the reference pel set [(r0,0), (r0,1), (r0,2), (r0,3)] with a pel subset [(s4,7), (s4,8), (s4,9), (s4,10)] of the search image set of pels.

To support cumulative Masked Quad SAD operation, preferably the data previously stored in the SAD value memory array 130 is used as a third input when the microinstruction is provided to perform the Masked Quad SAD operation. For performing the searches with respect to Block 4,4, Block 4,5, Block 4,6 and Block 4,7 of the search image, the four words, W4,4, W4,5, W4,6 and W4,7, respectively are used to accumulate the new result of each cumulative Masked Quad SAD operation performed for the respective block search.

Preferably, in advance of the first Masked Quad SAD operation of the search with respect to Block 4,4, Block 4,5, Block 4,6 and Block 4,7 of the search image, the four words, W4,4, W4,5, W4,6 and W4,7 in the SAD value memory array 130 were initialized to 0. This permits, the first Masked Quad SAD operation to also have the data stored in the four words, W4,4, W4,5, W4,6 and W4,7 input as a third input for the first Masked Quad SAD operation without altering the result thereof.

FIG. 5 illustrates a second Masked Quad SAD operation for the cumulative searches commenced in FIG. 4 with respect to Block 4,4, Block 4,5, Block 4,6 and Block 4,7 of the search image. Such a second Masked Quad SAD operation is preferably commenced through providing a microinstruction to the execution unit of a processor that identifies the Masked Quad SAD operation as the operation to be performed using specified data for first and second operation inputs. A shift type instruction would be executed in advance of the second Masked Quad SAD operation so that pel data for the set of reference pels, [(r0,4), (r0,5), (r0,6), (r0,7)] is specified as the first input 301 for the second Masked Quad SAD operation and pel data for the set of search image pels, [(s4,8), (s4,9), (s4,10), (s4,11), (s4,12), (s4,13), (s4,14), (s4,15)] is specified as the second input 302 for the second Masked Quad SAD operation. The result of the first Masked Quad SAD operation for this search is the data stored in the four words, W4,4, W4,5, W4,6, W4,7 in the SAD value memory array 130 which is input as a third input 303 for the second Masked Quad SAD operation

The second Masked Quad SAD operation is then performed by the execution unit of the processor as described above to produce an output 304 of four sixteen-bit that represent four comparison results with respect to the reference pel set of pels and four subsets of a search image set of pels that is directed to the SAD value memory array 130 and stored in four words, W4,4, W4,5, W4,6 and W4,7 overwriting the prior result that had been used as the third input for the second Masked Quad SAD operation.

As a result of the second Masked Quad SAD operation, each of the four words represents an accumulation of comparative calculation result for eight pels. For example, the word stored at word W4,4 at the completion of the operation illustrated in FIG. 5 represents the prior comparison result for the first Masked SAD operation performed with respect to search image Block 4,4 per FIG. 4 accumulated with the comparison result of the reference pel set [(r0,4), (r0,5), (r0,6), (r0,7)] with the pel subset [(s4,8), (s4,9), (s4,10), (s4,11)] of the search image set of pels [(s4,8), (s4,9), (s4,10), (s4,11), (s4,12), (s4,13), (s4,14), (s4,15)].

Fourteen further Cumulative Masked Quad SAD operations continue with respect to successive 4-pel sets of the reference image 110 and 8-pel sets of the search image 120, to complete the searches with respect to search image Block 4,4, Block 4,5, Block 4,6 and Block 4,7. The last Cumulative Masked Quad SAD operation in such searches, using values for the reference pel set [(r3,12), (r3,13), (r3,14), (r3,15)] as the input for the first input 52, and the values of the search image set of pels[(s7,16), (s7,17), (s7,18), (s7,19), (s7,20), (s7,21), (s7,22), (s7,23)] as input for the second input 54, and the cumulative values stored in the four words, W4,4, W4,5, W4,6 and W4,7 of the memory 130 as the input for the third input 62 of circuit 50. Since the bird object within the reference image 110 corresponds to in position exactly to the bird object in Block 4,7 of the search image 120, the final result of the four searches stored in the four words, W4,4, W4,5, W4,6 and W4,7 will result in the value of the word W4,7 closest to 0 indicating that the best match of the location of the bird object in the search image is with respect to search image Block4,7.

As an alternative to four concurrent cumulative searches using the Masked Quad Sad operation as discussed above with respect to FIGS. 3-5, four individual searches using the cumulative Masked SAD operation discussed with respect to FIG. 2 can be performed to produce the same results. For example, a first search with respect to search image Block 4,4 using the Masked SAD operation of FIG. 2 can be commenced through providing a microinstruction to the execution unit of a processor that identifies the cumulative Masked SAD operation of FIG. 2 as the operation to be performed using specified data for first, second and third operation inputs as described with respect to FIG. 2. For the first Masked SAD operation of the search, the pel values of set of reference pels, [(r0,0), (r0,1), (r0,2), (r0,3)] is specified as a first input; the pel values of a set of search image pels, [(s4,5), (s4,6), (s4,7), (s4,8)] is specified as the second input. An initialized zero value stored at Word W4,4 in the SAD value memory array 130 serves as the data for the third input. The output of such first Masked SAD operation is stored in word, W4,4 overwriting the initialized zero value. The search with respect to search image Block 4,4 continues using Masked SAD operations until an accumulated value with respect to the entire reference image is obtained and stored in word, W4,4.

A second search with respect to search image Block 4,5 using the Masked SAD operation can be commenced with a first Masked SAD operation using pel data with respect to the set of reference pels, [(r0,0), (r0,1), (r0,2), (r0,3)] and the set of search image pels, [(s4,5), (s4,6), (s4,7), (s4,8)]. A third search with respect to search image Block 4,6 using the Masked SAD operation can be commenced with a first Masked SAD operation using pel data with respect to the set of reference pels, [(r0,0), (r0,1), (r0,2), (r0,3)] and the set of search image pels, [(s4,6), (s4,7), (s4,8), (s4,9)]. Finally, a fourth search with respect to search image Block 4,7 using the Masked SAD operation can be commenced with a first Masked SAD operation using pel data with respect to the set of reference pels, [(r0,0), (r0,1), (r0,2), (r0,3)] and the set of search image pels, [(s4,7), (s4,8), (s4,9), (s4,10)] is specified as the second input.

Although the same resultant data can be produced by conducting four cumulative searches using the Masked SAD operation, the use of the Masked Quad-SAD operation provides the four search comparison results at an accelerated rate since it involves only one-fourth of the number of data shifting operations of inputted values.

The above examples are not intended to be limiting and can be implemented with non-power-of-two sized values. In practice, it may be desirable to use 2-10-10-10 image data. In such a situation, an example multi-pel SAD or Masked SAD operation could preferably perform comparison calculations with respect to three (3) reference pels and three (3) searched image pels. The “Quad” SAD (or Masked “Quad” SAD) operation in such an example could be implemented as a “Tri” SAD That would receive six (6) searched image pels and perform 9 compares (three (3) sets of three (3)) with a single instruction. An example Tri SAD circuit in such case can include three (K=3) arithmetic circuits, each configured to process pel data for a set of three (N=3) pels received via a reference image input with pel data for a search image pel subset of three (N=3) pels of a set of six (M=6) pels received via a search image pel input to produce three (3) twenty-one-bit SAD values packed inside a 64 bit word.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine.

Embodiments of the invention may be represented as instructions and data stored on a computer readable memory. For example, aspects of the invention may be included in a hardware description language (HDL) code stored on such computer readable media. Such instructions, when processed may generate other intermediary data (e.g., net lists, GDS data, or the like) that can be used to create mask works that are adapted to configure a manufacturing process (e.g., a semiconductor fabrication facility). Once configured, such a manufacturing process is thereby adapted to manufacture processors or other semiconductor devices that embody aspects of the present invention.

What is claimed is:

1. An apparatus for facilitating the processing of video image data:
a first input configured to receive pel data for a set of a predetermined number N of pels of a reference image, where N is at least 2;
a second input configured to receive pel data for a set of a predetermined number M of pels of a search image where M is greater than N;
a plurality of K arithmetic circuits, each configured to process the pel data for the set of N pels received via the first input with pel data for a search image pel subset of N pels of the set of M pels received via the second input such that the search image pel subset used by each arithmetic circuit contains pel data with respect to different subsets of the set of M pels; and
an output configured to output a set of K data elements where each element corresponds to a comparison result generated with respect to one of the search image pel subsets.

2. The apparatus of claim 1 further comprising:
a third input configured to receive a set of K elements previously produced from the output with respect to the subsets of the set of M pels for which pel data is being received by the second input;
wherein each arithmetic circuit is configured to accumulate into the comparison result that it generates with respect to one of the search image pel subsets a corresponding subset data element of the set of K elements received via the third input.

3. The apparatus of claim 2 wherein N=4, M=8 and K=4 and pel data for each pel is a byte of eight bits.

4. The apparatus of claim 1 wherein:
the first input is configured to receive pel data for N consecutive pels of the reference image; the second input is configured to receive pel data for M consecutive pels of the search image; and
each arithmetic circuit is configured to process the pel data for N consecutive pels of the reference image with pel data for a respective search image pel subset of N consecutive pels of the search image.

5. The apparatus of claim 1 wherein each arithmetic circuit is configured to process the pel data for the set of N pels of the reference image with pel data for the respective search image pel subset by calculating the absolute value of the difference of a pel value of each pel of the N reference image pels with a pel value of a corresponding pel of the respective search image pel subset.

6. The apparatus of claim 1 where the reference image is defined by object pels and background pels such that the pel data for an object pel represents a value within a predetermined range and the pel data for a background pel is set to a fixed value outside the predetermined range, the IC wherein:
each arithmetic circuit includes:
N processing circuits, each configured to process the pel data for a pel of the set of N pels of the reference image with pel data of a corresponding pel of the respective search image subset such that the a comparative value is produced where the pel of the reference image is an object pel and a zero value is produced where the pel of the reference image is a background pel; and
a combiner component configured to selectively combine the values produced by the N processing circuits and to produce a collective comparative value with respect to the respective search image pel subset as one of the K data elements.

7. The apparatus of claim 6 further comprising:
a third input configured to receive a set of K elements previously produced from the output with respect to the subsets of the set of M pels for which pel data is being received by the second input;
wherein each arithmetic circuit is configured to accumulate into the comparison result that it generates with respect to one of the search image pel subsets a corresponding subset data element of the set of K elements received via the third input.

8. The apparatus of claim 6 wherein:
the first input is configured to receive pel data for N consecutive pels of the reference image;
the second input is configured to receive pel data for M consecutive pels of the search image; and
each arithmetic circuit is configured to process the pel data for N consecutive pels of the reference image with pel data for a respective search image pel subset of N consecutive pels of the search image.

9. The apparatus of claim 6 wherein each arithmetic circuit is configured to process the pel data for the set of N pels of the reference image with pel data for the respective search image pel subset by calculating the absolute value of the difference of a pel value of each pel of the N reference image pels with a pel value of a corresponding pel of the respective search image pel subset.

10. The apparatus of claim 9 wherein N=4, M=8 and K=4 and pel data for each pel is a byte of eight bits.

11. The apparatus of claim 1 configured as a video capture device.

12. The apparatus of claim 1 configured as a video display device.

13. A method of processing of video image data:
inputting pel data for a set of a predetermined number N of pels of a reference image, where N is at least 2;
inputting pel data for a set of a predetermined number M of pels of a search image where M is greater than N;
conducting K arithmetic processes with respect to the inputted pels, each arithmetic process processing the pel data for the set of N pels of the reference image with pel data for a search image pel subset of N pels of the set of M pels of the search image such that the search image pel subset used by each arithmetic process contains pel data with respect to different subsets of the set of M pels; and
outputting a set of K data elements where each element corresponds to a comparison result generated with respect to one of the search image pel subsets.

14. The method of claim 13 further comprising:
inputting a set of K elements previously produced from the output with respect to the subsets of the set of M pels for which pel data is input;
wherein each arithmetic process accumulates into the comparison result that is respectively generated with respect to one of the search image pel subsets a corresponding subset data element of the inputted set of K elements.

15. The method of claim 14 performed where N=4, M=8 and K=4 and pel data for each pel is a byte of eight bits.

16. The method of claim 13 wherein:
pel data for N consecutive pels of the reference image is input;
pel data for M consecutive pels of the search image is input; and
each arithmetic process processes the pel data for N consecutive pels of the reference image with pel data for a respective search image pel subset of N consecutive pels of the search image.

17. The method of claim 13 wherein each arithmetic process processes the pel data for the set of N pels of the reference image with pel data for the respective search image pel subset by calculating the absolute value of the difference of a pel value of each pel of the N reference image pels with a pel value of a corresponding pel of the respective search image pel subset.

18. The method of claim 13 where the reference image is defined by object pels and background pels such that the pel data for an object pel represents a value within a predetermined range and the pel data for a background pel is set to a fixed value outside the predetermined range, the method wherein:
each arithmetic process includes:
N comparison sub processes, each processing the pel data for a pel of the set of N pels of the reference image with pel data of a corresponding pel of the respective search image subset such that the a comparative value is produced where the pel of the reference image is an object pel and a zero value is produced where the pel of the reference image is a background pel; and
a combiner process that selectively combines the values produced by the N comparison sub processes to produce a collective comparative value with respect to the respective search image pel subset as one of the K data elements.

19. The method of claim 18 further comprising:
inputting a set of K elements previously produced from the output with respect to the subsets of the set of M pels for which pel data is input;
wherein each arithmetic process accumulates into the comparison result that it generates with respect to one of the search image pel subsets a corresponding subset data element of the inputted set of K elements.

20. The method of claim 18 wherein:
pel data for N consecutive pels of the reference image is input;
pel data for M consecutive pels of the search image is input; and
each arithmetic process processes the pel data for N consecutive pels of the reference image with pel data for a respective search image pel subset of N consecutive pels of the search image.

21. The method of claim 18 wherein each arithmetic process processes the pel data for the set of N pels of the reference image with pel data for the respective search image pel subset by calculating the absolute value of the difference of a pel value of each pel of the N reference image pels with a pel value of a corresponding pel of the respective search image pel subset.

22. The method of claim 21 performed where N=4, M=8 and K=4 and pel data for each pel is a byte of eight bits.

23. The method of claim 24 performed by an integrated circuit in response to a microinstruction that identifies a Masked Quad SAD operation to be performed.

24. The method of claim 15 performed by an integrated circuit in response to a microinstruction that identifies a Quad SAD operation to be performed.

25. A computer-readable storage medium storing a set of instructions for execution by a processor to facilitate processing of video image data that is adapted to:
receive pel data for a set of a predetermined number N of pels of a reference image, where N is at least 2;
receive pel data for a set of a predetermined number M of pels of a search image where M is greater than N;
conduct K arithmetic processes with respect to the received pels, each arithmetic process processing the pel data for the set of N pels of the reference image with pel data for a search image pel subset of N pels of the set of M pels of the search image such that the search image pel subset used by each arithmetic process contains pel data with respect to different subsets of the set of M pels; and
output a set of K data elements where each element corresponds to a comparison result generated with respect to one of the search image pel subsets.

26. The computer-readable storage medium of claim 25, wherein the instructions are identified by a single OpCode that is adapted to:
receive 32 bits of pel data representing four consecutive pels of the reference image;
receive 64 bits of pel data representing eight consecutive pels of the search image; and
conduct four arithmetic processes that each process the pel data for the four consecutive pels of the reference image with pel data for the respective search image pel subset by calculating the absolute value of the difference of a pel value of each pel of the four reference image pels with a pel value of a corresponding pel of the respective search image pel subset; and
output four 16 bit data elements.

27. The computer-readable storage medium of claim 25, wherein the set of instructions is for execution by the processor to facilitate processing of video image data where the reference image is defined by object pels and background pels such that the pel data for an object pel represents a value within a predetermined range and the pel data for a background pel is set to a fixed value outside the predetermined range, wherein:
each conducted arithmetic process includes:
N comparison sub processes that each process the pel data for a pel of the set of N pels of the reference image with pel data of a corresponding pel of the respective search image subset such that the a comparative value is produced where the pel of the reference image is an object pel and a zero value is produced where the pel of the reference image is a background pel; and
a combiner process that selectively combines the values produced by the N comparison sub processes to produce a collective comparative value with respect to the respective search image pel subset as one of the K data elements.

28. The computer-readable storage medium of claim 27, wherein the instructions are identified by a single OpCode that is adapted to:
receive 32 bits of pel data representing four consecutive pels of the reference image;
receive 64 bits of pel data representing eight consecutive pels of the search image; and
conduct four arithmetic processes that each process the pel data for the four consecutive pels of the reference image with pel data for the respective search image pel subset by calculating the absolute value of the difference of a pel value of each pel of the four reference image pels with a pel value of a corresponding pel of the respective search image pel subset; and
output four 16 bit data elements.

29. A computer-readable storage medium storing a set of instructions for execution by one or more processors to facilitate manufacture of circuitry within an integrated circuit that is adapted to:
receive pel data for a set of a predetermined number N of pels of a reference image, where N is at least 2;
receive pel data for a set of a predetermined number M of pels of a search image where M is greater than N;
conduct K arithmetic processes with respect to the received pels, each arithmetic process processing the pel data for the set of N pels of the reference image with pel data for a search image pel subset of N pels of the set of M pels of the search image such that the search image pel subset used by each arithmetic process contains pel data with respect to different subsets of the set of M pels; and
output a set of K data elements where each element corresponds to a comparison result generated with respect to one of the search image pel subsets.

30. The computer-readable storage medium of claim 29, wherein the instructions are hardware description language (HDL) instructions used for the manufacture of a device.

31. The computer-readable storage medium of claim 29, wherein the set of instructions is to facilitate manufacture of circuitry within an integrated circuit to facilitate processing of video image data where the reference image is defined by object pels and background pels such that the pel data for an object pel represents a value within a predetermined range and the pel data for a background pel is set to a fixed value outside the predetermined range, wherein:
each conducted arithmetic process includes:
N comparison sub processes that each process the pel data for a pel of the set of N pels of the reference image with pel data of a corresponding pel of the respective search image subset such that the a comparative value is produced where the pel of the reference image is an object pel and a zero value is produced where the pel of the reference image is a background pel; and
a combiner process that selectively combines the values produced by the N comparison sub processes to produce a collective comparative value with respect to the respective search image pel subset as one of the K data elements.

32. The computer-readable storage medium of claim 31, wherein the instructions are hardware description language (HDL) instructions used for the manufacture of a device.

33. An apparatus for facilitating the processing of video image data:
a first input configured to receive pel data for a plurality of pels of a reference image defined by object pels and background pels such that the pel data for an object
pel represents a value within a predetermined range and the pel data for a background pel is set to a fixed value outside the predetermined range;
a second input configured to receive pel data for a corresponding plurality of pels of a search image;
a corresponding plurality of processing circuits, each configured to process the pel data for a pel of the reference image received via the first input with pel data of a corresponding pel of the search image received via the second input such that a comparative value is produced where the pel of the reference image is an object pel and a zero value is produced where the pel of the reference image is a background pel; and
a combiner component configured to selectively combine the values produced by the plurality of processing circuits and to output a collective comparative value with respect to the plurality of search image pels.

34. The apparatus of claim 33 further comprising:
a third input configured to receive a collective comparative value previously produced by the combiner with respect to the plurality of pels for which pel data is received by the second input;
wherein the combiner is configured to accumulate the previously produced collective comparative value into the collective comparative value that it produces with respect to the plurality of pels for which pel data is received by the second input.

35. The apparatus of claim 34 where pel data for each pel is a byte of eight bits wherein:
the first input is configured to receive pel data for a set of four pels of the reference image such that the pel data for a background pel is set to a zero value;
the second input is configured to receive pel data for a set of four pels of the search image; and
the plurality of processing circuits is four in number.

36. The apparatus of claim 33 wherein the processing circuits are configured to process the pel data for the pels of the reference image with pel data for pels of the search image by calculating the absolute value of the difference of a pel value of each pel of the reference image set of pels with a pel value of a corresponding pel of the search image set of pels.

37. The apparatus of claim 36 where pel data for each pel is a byte of eight bits wherein:
the first input is configured to receive pel data for a set of four pels of the reference image such that the pel data for a background pel is set to a zero value;
the second input is configured to receive pel data for a set of four pels of the search image; and
the plurality of processing circuits is four in number.

38. The apparatus of claim 33 configured as a video capture device.

39. The apparatus of claim 33 configured as a video display device.

40. A method of processing of video image data:
inputting pel data for a plurality of pels of a reference image defined by object pels and background pels such that the pel data for an object pel represents a value within a predetermined range and the pel data for a background pel is set to a fixed value outside the predetermined range;
inputting pel data for a corresponding plurality of pels of a search image;
conducting a corresponding plurality of processes with respect to the inputted pel data, each process performed with respect to pel data for a different pel of the reference image and pel data of a corresponding different pel of the search image such that:
a comparative value is produced where the pel of the reference image is an object pel, and
a zero value is produced where the pel of the reference image is a background pel; and
selectively combining the values produced by the plurality of processing circuits and outputting a collective comparative value with respect to the plurality of search image pels.

41. The method of claim 40 further comprising:
inputting a collective comparative value previously produced with respect to the plurality of pels of the search image for which pel data is input;
wherein the combining accumulates the inputted previously produced collective comparative value into the collective comparative value that is output.

42. The method of claim 41 where pel data for each pel is a byte of eight bits wherein:
pel data for a set of four pels of the reference image is input where the pel data for a background pel is set to a zero value;
pel data for a set of four pels of the search image is input; and
four of the processes are conducted with respect to the inputted pel data.

43. The method of claim 40 wherein the plurality of processes process the pel data for the pels of the reference image with pel data for pels of the search image by calculating the absolute value of the difference of a pel value of each pel of the reference image set of pels with a pel value of a corresponding pel of the search image set of pels.

44. The method of claim 43 where pel data for each pel is a byte of eight bits wherein:
pel data for a set of four pels of the reference image is input where the pel data for a background pel is set to a zero value;
pel data for a set of four pels of the search image is input; and
four of the processes are conducted with respect to the inputted pel data.

45. The method of claim 44 performed by an integrated circuit in response to a microinstruction that identifies a Masked SAD operation to be performed.
